(19) United States
(12) Patent Application Publication
(10) Pub. No.: US 2024/0220341 A1
(43) Pub. Date: Jul. 4, 2024

(54) INDEPENDENT CONTAINERIZED USER-DEFINED FUNCTIONS

(71) Applicant: Teradata US, Inc., San Diego, CA (US)

(72) Inventors: Michael George Coutts, San Diego, CA (US); Mark Andrew Sandan, La Jolla, CA (US); John Douglas Frazier, Ramona, CA (US)

(21) Appl. No.: 18/525,325

(22) Filed: Nov. 30, 2023

Related U.S. Application Data
(60) Provisional application No. 63/478,147, filed on Dec. 31, 2022.

(51) Int. Cl. G06F 9/54

(52) U.S. Cl. CPC G06F 9/543; G06F 9/544

(57) ABSTRACT

A system may include a storage device. The storage device may store a plurality of user-defined functions (“UDFs”). Each of the plurality of UDFs may be containerized to allow each UDF to be executed using content unshared with other UDFs. The storage device may also include a plurality of data objects. The system may further include a plurality of processing nodes. At least one processing node may receive a call to execute one of the plurality of UDFs on at least one of the plurality of data objects. The at least one processing node may execute the called UDF on the at least one of the plurality of data objects. A method and computer-readable medium are also disclosed.

### CLAIM OF PRIORITY

This application claims the benefit of priority under 35 U.S.C. § 119(e) of U.S. Provisional Patent Application Ser. No. 63/478,147 filed on Dec. 31, 2022, which is hereby incorporated by reference herein in its entirety.

### BACKGROUND

User-defined functions (“UDFs”) are powerful functions that allow specific functionality to be applied within an analytic environment, such as a relational database management system. UDFs provide a mechanism by which default analytic and processing capabilities of a database or other analytic environment may be extended to provide an advanced or customer-specific set of capabilities. Such UDFs allow relevant query-language to execute the function to carry out the intended result. While UDFs are powerful in their traditional usage, they do have shortcomings. For example, in a typical setting, UDFs share libraries requiring a recompiling of all UDFs sharing a library when it is only a single UDF that needs to be recompiled. Such connection between the UDFs requires expensive processing resources and time. However, typical database implementation binds UDFs together as part of the deployment and/or installation and restrict their individual requirements (both in terms of kernel capability and associated library(ies)). This restricts both the developer in what can be combined and the operator in what can be deployed. Though an independent containerized UDF approach, many of these issues may be mitigated through internal container controls as well as external container configuration and access controls.

Containers (e.g., Docker, LLC, etc.) allow for the encapsulation of application processing logic within a “sandboxed” environment that shares the underlying operating system (as opposed to Virtual Machines, which provide for sandboxing via providing a complete operating system environment). Containerization allows the minimum amount of software needed to execute an application independently.

Because traditional UDFs do not allow independence from one another, it would be desirable to allow the independent containerization of UDFs.

### SUMMARY

According to one aspect of the disclosure, a system may include a storage device. The storage device may store a plurality of user-defined functions (“UDFs”). Each of the plurality of UDFs may be containerized to allow each UDF to be executed using content unshared with other UDFs. The storage device may also include a plurality of data objects. The system may further include a plurality of processing nodes. At least one processing node may receive a call to execute one of the plurality of UDFs on at least one of the plurality of data objects. The at least one processing node may execute the called UDF on the at least one of the plurality of data objects.

According to another aspect of the disclosure, a method may include receiving, with at least one processing node, a function call to execute a containerized UDF. The containerized UDF may be stored with other containerized UDFs in a storage device. The containerized UDF may be executable using content unshared with the other containerized UDFs. The method may further include executing, with the at least one processing node, the containerized UDF on at least one data object referenced in the function call.

According to another aspect of the disclosure, a plurality of instructions may be executable with a processor. The plurality of instructions may include instructions to receive, with the processor, a function call to execute a containerized UDF. The containerized UDF may be stored with other containerized UDFs in a storage device. The containerized UDF may be executable using content unshared with the other containerized UDFs. The plurality of instructions may further include instruction to execute, with the processor, the containerized UDF on at least one data object referenced in the function call.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of an example software environment capable of supporting an independent containerized user-defined function.

FIG. 6 is an operational flow diagram of an example development process of an independent containerized user-defined function.

FIG. 7 is a block diagram of an example software environment used to develop and debug independent containerized user-defined functions.

FIG. 8 is an example block diagram of an example of access controls used to control independent containerized user-defined functions.

FIG. 9 an operational flow diagram of a deployment process for an independent containerized user-defined function.

FIG. 10 is a block diagram of an example deployment of an independent containerized user-defined function to multiple schemas.

FIG. 11 is a block diagram of an example use of independent containerized user-defined function version associated with different groups of processing nodes.

### DETAILED DESCRIPTION OF THE FIGURES

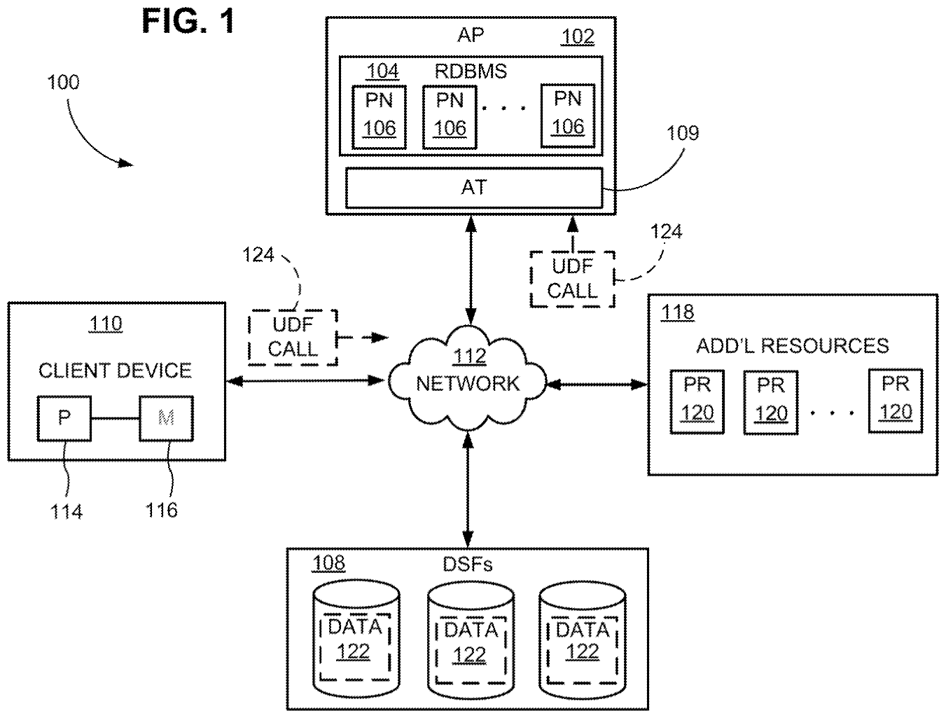

FIG. 1 is block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

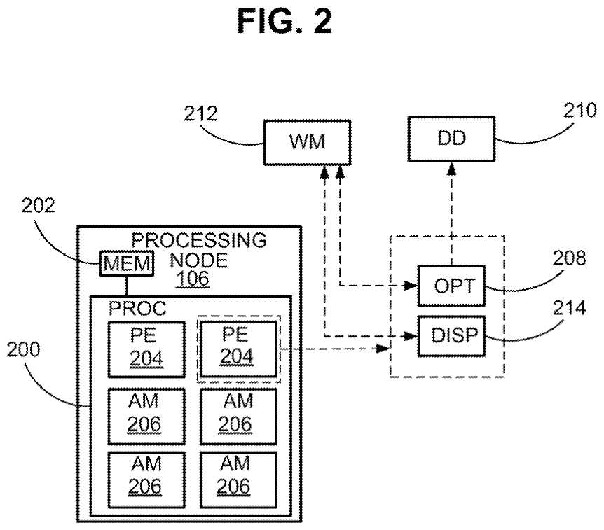

FIG. 2 is an example of a processing node 106, which may include one or more physical processors 200 and memory(ies) 202. The memory 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, that includes instructions executable with the processor 200 or other processor to implement one or more of the features of the module. When any one of the modules includes the portion of the memory that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Active Data Warehousing System®.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIG. 1, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 102 stores data 122 in one or more tables in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

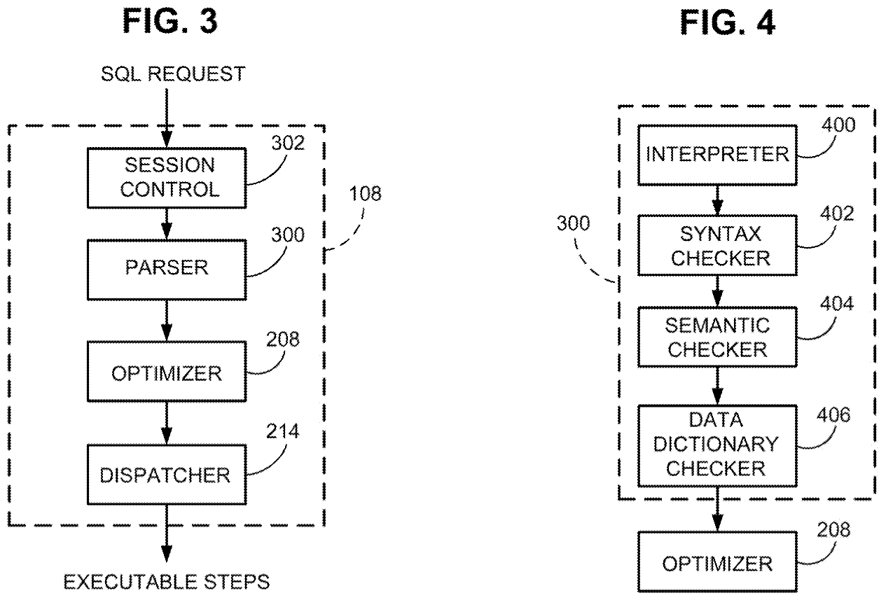

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 108 for purposes of illustration.

The data dictionary module 210 may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission by a user and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

As shown in FIG. 1, the client device 110 may provide a UDF call 124, which may be part of some analytic platform task associated with the analytic platform 102, such as a database query. The UDF call 124 may be received by the analytic platform 102, and specifically, in one example, the RDBMS 104. The UDF call 124 may reference a UDF stored in the RDBMS 104, which in one example may be stored in the data dictionary 210. The RDBMS 104 execute the UDF in conjunction with the associated database query in the UDF call 124.

In one example, an independent containerized UDF may be used to independently contain information needed to properly execute the independent containerized UDF (“I-C-UDF”) without necessity of sharing other content with other UDFs. This allows each I-C-UDF to manage only the code and libraries that is required. Use of an I-C-UDF also allows independent installation, upgrade, and deletion without impacting other I-C-UDFs.

In one example, an independent UDF within the RDBMS 104 or other analytic tool (“AT”) 109 (e.g., open analytic framework) may be separated out into a container such that the independent UDF can be more easily developed, debugged, deployed, and secured. Containerization of a UDF also allows increased specific control through access controls and container configuration to provide for “least privilege” access to the facilities of the RDBMS 104 or analytic environment 100 (e.g., network 112, file system, and inter-process communication). Further, through container configuration each UDF deployed may have its own resource usage (e.g., CPU/Memory) more tightly controlled.

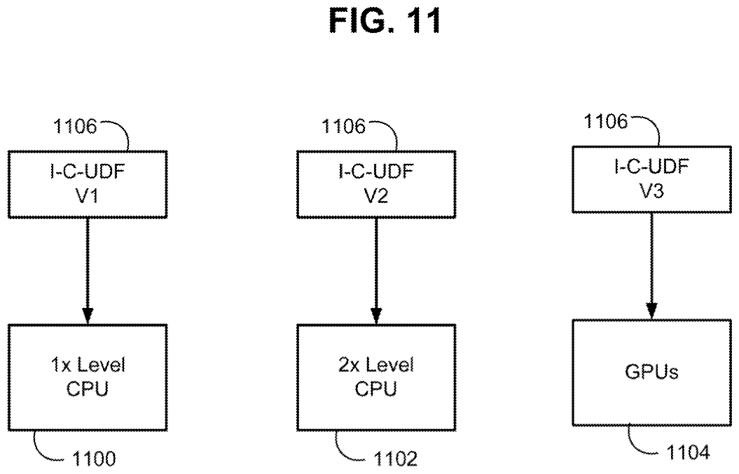

Another benefit of I-C-UDFs is the ability to develop and debug outside of the RDBMS 104 or analytic environment due to a container allowing data fed through an input stream that may be processed by an I-C-UDF to produce an output stream of results that may be examined for correctness. Additionally, I-C-UDFs may be more efficiently and securely pushed to a container registry as part of the deployment process. Further, any such I-C-UDF managed within a container registry may then be deployed within the RDBMS 104 or analytic environment 100 through updating any part of the data dictionary/schema to provide a “reference to a function entry point” within the container while allowing for a standard container registry “pull” of the independent containerized UDF image to the selected/tasked processing nodes of the RDBMS 104 and/or analytic environment 100. I-C-UDF containers may be directed to specific groups of processing nodes within the RDBMS 104 or analytic environment 100, whether that be to best utilize different sizes of processing nodes or specialized hardware (e.g. graphic processing units (“GPUs”) (see FIG. 11)).

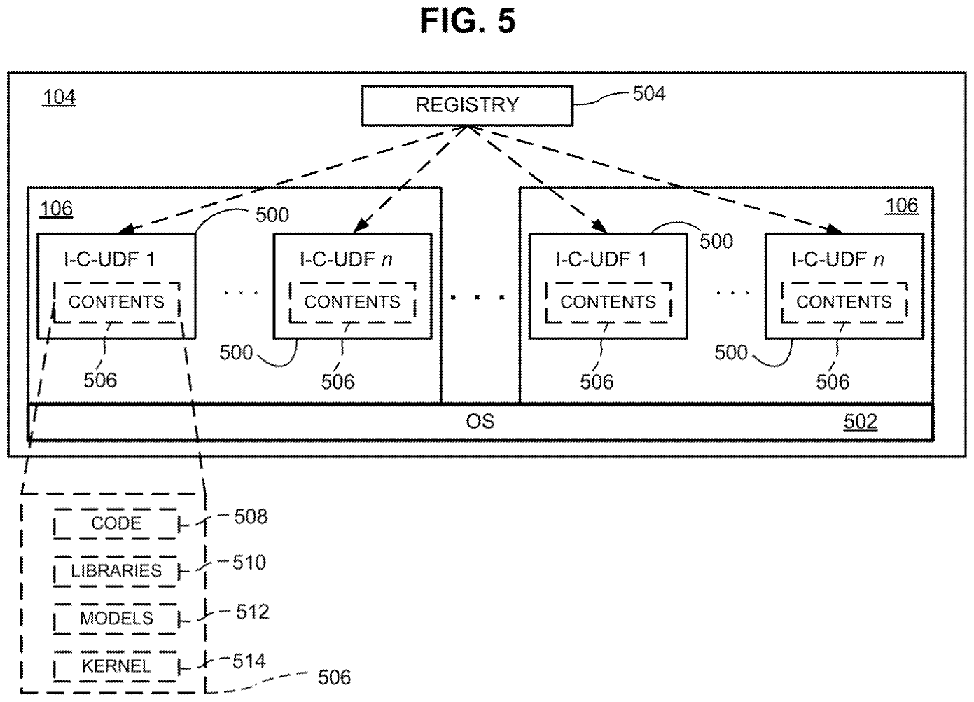

FIG. 5 is a block diagram of a portion of the analytic environment 100 in a software environment, which may include an I-C-UDF process capable of supporting an I-C-UDF 500. In one example, this may be the RDBMS 104. The RDBMS 104 may include an operating system 502 for each processing node 106 on which to function. Containerization of the I-C-UDFs 500 allows a single, pre-compiled I-C-UDF 500 to be created and pushed to a container registry 504. In FIG. 5, the registry 504 is shown to be part of the RDBMS 104. In other examples the container registry 504 may be a registry located outside the RDBMS 104. In such a scenario, the RDBMS 104 may pull down an I-C-UDF 500 from the registry 504 when a UDF call is received. Once the I-C-UDF 500 is pulled down, the RDBMS 104 may maintain the I-C-UDF in memory or on disk as represented generally by the container registry 504. In other examples, the container registry 504 may exist elsewhere within the RDBMS 104. In the example of FIG. 1, n different I-C-UDFs 500 may exist and are capable of being replicated across any processing node 106 that pulls an I-C-UDF 500 from the container registry 504. Each processing node 106 may be capable of pulling any of the n I-C-UDFs 500 as needed.

Each I-C-UDF 500 may include contents 506, which may vary from each other based on the I-C-UDF 500. In one example, each I-C-UDF 500 may include uncompiled or interpretable code 508 and specific library(ies) 510 associated with the I-C-UDF 500. Optional data or models 512 that support the operation of the I-C-UDF 500, as well as the base kernel processes 514 that the container provides may be included as the contents 506.

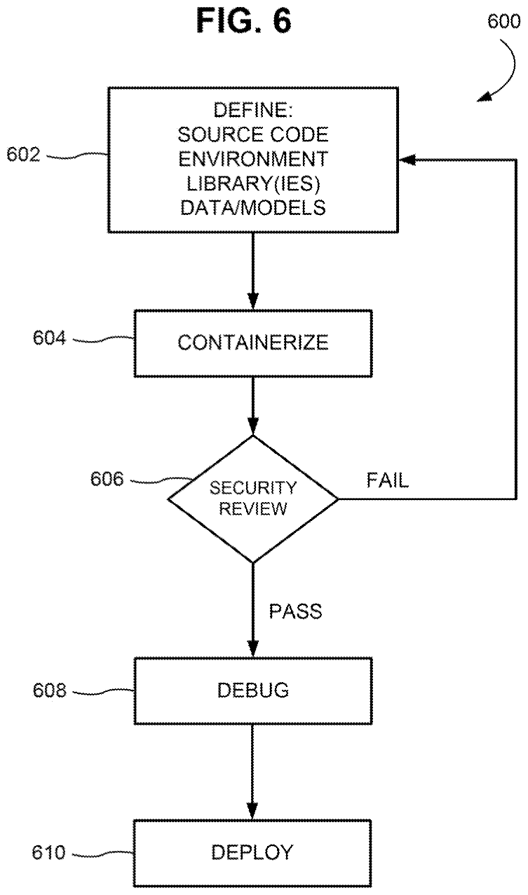

FIG. 6 is an operational flow diagram of an example development process (600) of an I-C-UDF 500. In one example, a definition process (602) may include various activities, such as defining source code 508 for the I-C-UDF in some particular language (e.g., C, C++, Java, Shell, Python, R, Rust, Go, etc.). The definition process (602) may also include definition of architectural requirements of a target environment (e.g., Teradata, Oracle, SQL server, etc.) The definition process (602) may also include definition of one or more libraries 510 associated with the chosen language and specific requirements of the function/analytic being developed. The definition process (602) may also include definition of binary data and/or models 512 (e.g., machine learning, artificial intelligence, etc.). With regard to the environment definition, one or more environmental parameters/values may be used to fully define the I-C-UDF 500.

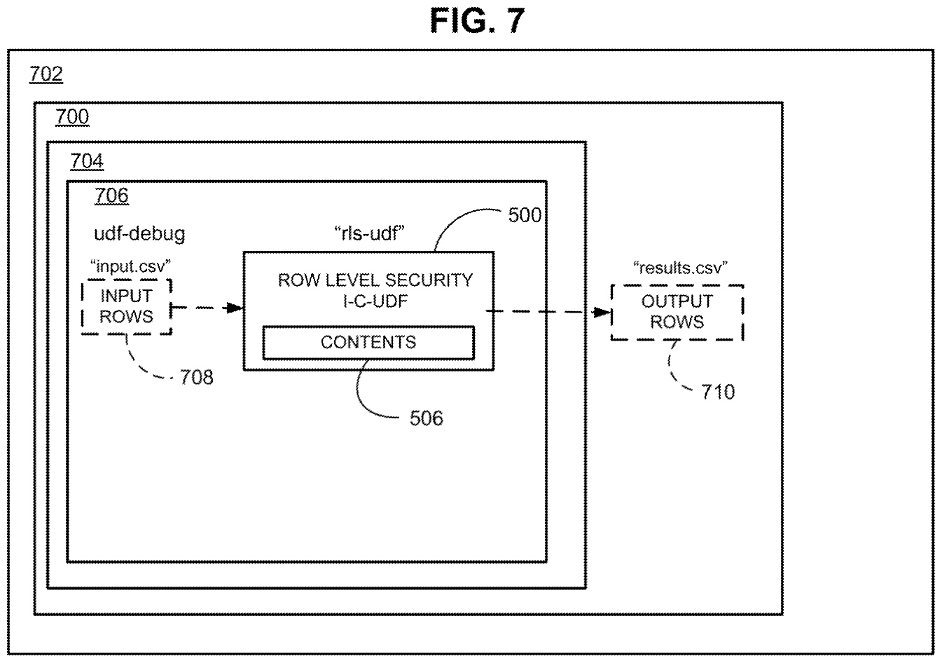

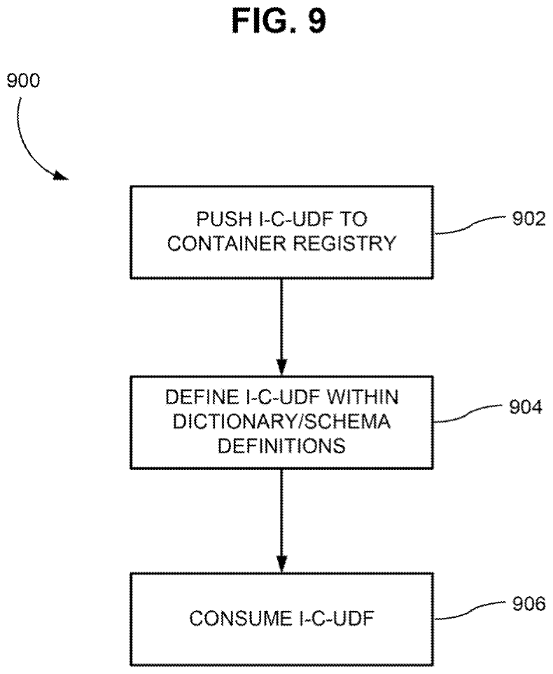

Once the definition process (602) is complete, the development process (600) may implement a containerization process (604). Within the development process (600) a continuous integration (“CI”) process may be used to execute the containerization process (604). While there are multiple approaches available (e.g., Docker, Docker Multi-Stage Builds, Rocket, etc.), they all result in a container image within which an I-C-UDF 500 may be Open Container Initiative (“OCI”)-compliant. The development process (600) may also include one or more security review processes (606) that are available for containers and one appropriate to the language/architecture/environment selected may be employed in the development process (600). I-C-UDFs 500 that fail the security review process(es) 606 may be returned to the definition process (602) for remediation for further submittal and debug. Any I-C-UDF 500 that passes security review process(es) (606) may progress to a debug process (608) (see FIG. 7) and ultimately a deployment process (610) (see FIG. 9).

FIG. 7 is a block diagram of an example of how an I-C-UDF 500 may be more easily developed and debugged, as opposed to traditional UDFs, by executing the I-C-UDFs 500 in a software environment 700 independent of a database, such as RDBMS 104, or other analytic environment. In one example, the debugging software environment 700 may be hosted on an operating system 702 to the target database system (e.g., RDBMS 104) or other analytic environment (e.g., analytic environment 100) and utilize a compatible container orchestration layer 704. In one example, a console application (herein referred to as “udf-debug”) 706 may take as parameters the individually named I-C-UDF 500 (named “rls-udf”) to be debugged along with input rows (data) 708 illustrated, referred to as “input.csv”, (a comma separated value “CSV”) file may represent one or more database or analytic environment data rows with commas [“,”] or other separators that can represent a known data set) as an input to the I-C-UDF 500 (which in this example drives the row-level-security I-C-UDF 500 that may use well-known values in a well-known column within the input rows to “filter” the output). Optionally, environmental parameters, such as the user-role, might be consumed from a command line and injected into the container to provide it a clearer context for its operation. Such a console I-C-UDF debug application 706 may consume the output of the I-C-UDF 500 in its container and per the console invocation, it may generate, in this example, output row(s) 710 as a “results.csv” file, which may be examined through various means (e.g. direct observation, automated inspection, etc.) to validate that the specified input rows 708 and environmental parameters were processed correctly via the I-C-UDF 500 in order to provide the appropriate results.

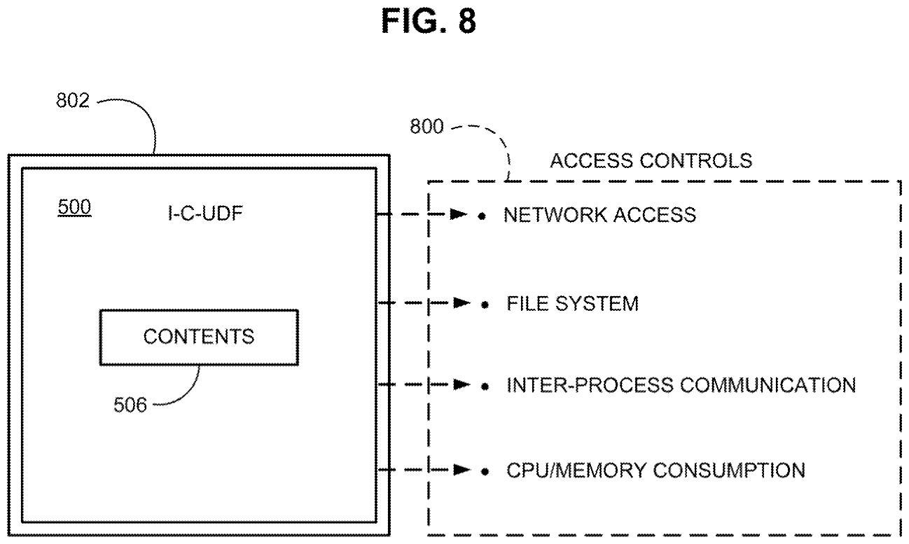

FIG. 8 is an example of how specific access controls 800 might manage the power and reach of each I-C-UDF 500 such that they may be more closely controlled. As opposed to traditional UDFs, each I-C-UDF 500 may be more specifically controlled through individual access controls 800 and container configuration 802 to provide for “least privilege” access to the facilities of the RDBMS 104 or analytic environment 100. Access controls 800 may include network access, file system access, and inter-process communication for direct access from the operational contents (code/libraries via the kernel) of the I-C-UDF 500. As a function of container management and configuration 802, each I-C-UDF 500 deployed may have its resource usage (CPU/memory consumption) managed by the greater environment of FIG. 1 or the specific environments shown in FIG. 11.

FIG. 9 is an operational flow diagram of a deployment 900 of an I-C-UDF 500 that is executed via a container registry 504 to one or more processing nodes 106 of the RDBMS 104 or other analytic tool 109 within the analytic environment 100. The deployment mechanism is a two-fold process with an initial phase taking a completed and secured I-C-UDF 500 as an entity that can be deployed or “pushed” to a container registry (e.g., registry 504) (902) such that the I-C-UDF 500 may later be deployed/pulled/consumed from the container registry. Separately, the deploy process interacts with the RDBMS 104 and/or analytic platform 102 to define the I-C-UDF 500 within the various dictionary/schema definitions in the data dictionary 210 within the RDBMS 104 and/or analytic platform 102 (904). As part of such a definition, the RDBMS 104 and/or analytic platform 100 may consume (a-priori or on-demand), through a container “pull” operation, the appropriate I-C-UDF 500 from a well-known container registry (e.g. registry 504) into an associated file system, memory and/or execution environment of the RDMBS 104 and/or analytic platform 102 (906).

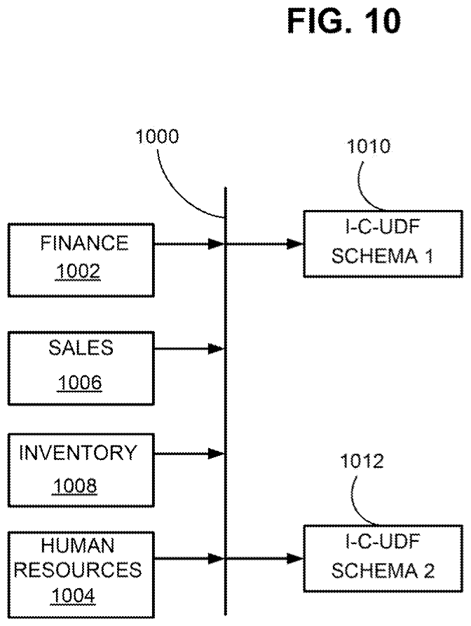

FIG. 10 illustrates how an I-C-UDF may be deployed to any schema within a database instance, such as RDBMS 104, or analytic environment 100 schema. To illustrate the difference between a primary database 1000 and its underlying schemas, highlighted are two typically sensitive databases as “Finance” 1002 and “Human Resources” 1004 among other databases “Sales” and “Inventory” that can both have a I-C-UDF 1010 and I-C-UDF 1012 dedicated to providing row level security associated with the tables of these schemas. The other schemas, sales 1006 and inventory 1008, do not have access to the aforementioned row level security but may have access to other I-C-UDFs that are not shown in FIG. 10. During operation, the underlying functionality of the I-C-UDFs 1010, 1012 may be the same, but each is tailored specifically to a particular schema, schema 1 for I-C-UDF 1010 and schema 2 for I-C-UDF 1012. The independent containerization of these UDFs allows each I-C-UDF 1010, 1012 to be specialized reducing computing-resource overhead typically required of I-C-UDF that are not containerized, while allowing higher degrees of security.

FIG. 11 is an example of I-C-UDFs that may be associated with different groups of processing nodes. In one example, multiple processing node groups may be used to carry out analytic tasks. In one example, each processing node group may vary by CPU types/sizes. For example, processing group 1100 may represent a 1× level of CPU capability, while processing group 1102 may represent a relative 2× level of CPU capability. Specialist hardware may also be used. For example, processing node group 1104 may represent graphic processing units (“GPUs”) that provide specialist algorithmic processing capabilities. Through the definition process described in FIG. 6, different versions of an I-C-UDF may be assigned to these different processing node groups in order to best utilize their capabilities. Similarly, through the definition process described in FIG. 6, an essentially-same I-C-UDF might be assigned different levels of resources (CPU/Memory). For example, three versions (V1, V2, and V3) of I-C-UDF 1106 may be created, each being matched with one of the processing node groups 1100, 1102, and 1104 in terms of container resource limitations.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

We claim:

1. A system comprising:
a storage device configured to store:
a plurality of user-defined functions (“UDFs”), wherein each of the plurality of UDFs is containerized to allow each UDF to be executed using content unshared with other UDFs; and
a plurality of data objects; and
a plurality of processing nodes, wherein at least one processing node is configured to:
receive a call to execute one of the plurality of UDFs on at least one of the plurality of data objects;
execute the called UDF on the at least one of the plurality of data objects.

2. The system of claim 1, wherein respective content of each of the plurality of UDFs allows each of the plurality of UDFs to be executed independently of the other UDFs.

3. The system of claim 1, wherein each of the plurality of containerized UDFs may be accessed from a registry in at least one of a local storage device and a remote storage device.

4. The system of claim 1, wherein the content of each of the plurality of UDFs may contain at least one of source code, environment, a library, and a model.

5. The system of claim 1, wherein each containerized UDF is defined within at least one of dictionary definitions and schema definitions.

6. The system of claim 1, wherein each containerized UDF may be a plurality of versions, wherein each version is configured to operate in accordance with a specific processing configuration.

7. The system of claim 1, wherein each containerized UDF may have a plurality of versions, wherein each containerized UDF is configured to a specific data store schema.

8. A method comprising steps of:
receiving, with at least one processing node, a function call to execute a containerized UDF, wherein the containerized UDF is stored with other containerized UDFs in a storage device, and wherein the containerized UDF is executable using content unshared with the other containerized UDFs; and
executing, with the at least one processing node, the containerized UDF on at least one data object referenced in the function call.

9. The method of claim 8, wherein respective content of each of the plurality of UDFs allows each of the plurality of UDFs to be executed independently of the other UDFs.

10. The method of claim 8, wherein each of the plurality of containerized UDFs may be accessed from a registry in at least one of a local storage device and a remote storage device.

11. The method of claim 8, wherein the content of each of the plurality of UDFs may contain at least one of source code, environment, a library, and a model.

12. The method of claim 8, wherein each containerized UDF is defined within at least one of dictionary definitions and schema definitions.

13. The method of claim 8, wherein each containerized UDF may be a plurality of versions, wherein each version is configured to operate in accordance with a specific processing configuration.

14. The method of claim 8, wherein each containerized UDF may have a plurality of versions, wherein each containerized UDF is configured to a specific data store schema.

15. A plurality of instructions executable with a processor, the plurality of instructions comprising:
instructions to receive, with the processor, a function call to execute a containerized UDF, wherein the containerized UDF is stored with other containerized UDFs in a storage device, and wherein the containerized UDF is executable using content unshared with the other containerized UDFs; and
instruction to execute, with the processor, the containerized UDF on at least one data object referenced in the function call.

16. The plurality of instructions of claim 15, wherein respective content of each of the plurality of UDFs allows each of the plurality of UDFs to be executed independently of the other UDFs.

17. The plurality of instructions of claim 15, wherein each of the plurality of containerized UDFs may be accessed from a registry in at least one of a local storage device and a remote storage device.

18. The plurality of instructions of claim 15, wherein the content of each of the plurality of UDFs may contain at least one of source code, environment, a library, and a model.

19. The plurality of instructions of claim 15, wherein each containerized UDF is defined within at least one of dictionary definitions and schema definitions.

20. The plurality of instructions of claim 15, wherein each containerized UDF may be a plurality of versions, wherein each version is configured to operate in accordance with a specific processing configuration.
